(19) United States
(12) Patent Application Publication
(10) Pub. No.: US 2005/0074112 A1
(43) Pub. Date: Apr. 7, 2005

(54) Technique for sharing information through an information assistance service

(76) Inventor: Timothy A. Timmins, Tigard, OR (US)

Correspondence Address: ALEX L. YIP;KAYE SCHOLER LLP, 425 PARK AVENUE, NEW YORK, NY, 10022, US

(21) Appl. No.: 10/676,197

(22) Filed: Oct. 1, 2003

(51) Int. Cl. H04M 3/42

(52) U.S. Cl. 379/218.01

(57) ABSTRACT

Search results and information found at an information source are transferred to a repository, such as an information depot, which is accessible by a number of means, including telephone and Internet. Data identifying a user are maintained at the repository. Information is received from the information source where it is associated with the identifying data. The information is then stored at the repository and released to selected recipients based on instructions from the user that include the identifying data. The repository may be accessed through an information assistance service. The identifying data are used to recognize the user when the user accesses the information at the repository. Recognition may be performed, e.g., using automatic number identification (ANI) or a user voiceprint.

### BACKGROUND OF THE INVENTION

The invention relates generally to an information assistance system and method. More specifically, the invention relates to a system and method for seeking and storing information through an information/call center.

The Internet has become the gateway to myriad sources of information. Users of the Internet are able to search these sources using one or more search criteria, and receive numerous results satisfying the criteria. Examples of such myriad sources include telephone directories such as white pages and yellow pages, map databases, event databases, transportation schedules, library catalogs, real estate listings, product catalogs, shopping comparison websites, etc. Many of these websites offer the user the option of sending the search results to others, usually to others' e-mail addresses, but sometimes to others' personal digital assistants (PDAs) or wireless phones. The user specifies the e-mail address or telephone number of the recipient, and the website sends to each recipient either the results themselves or a hyperlink to the results.

### SUMMARY OF THE INVENTION

Some problems with these delivery methods are that the user may want to send the results to more than one person, the people to whom the user wants to send the results do not have an e-mail address or PDA, or the user may want to save the results for later or send them to him- or herself when not able to access an e-mail account or a PDA.

The invention solves these problems by directing results and information a user finds at an information source to a central repository, such as an information depot, which is accessible by a number of means, including telephone and Internet. The invention includes searching an information source for desired information, receiving the desired information from the information source, and directing the information source to transfer the desired information to a repository via a communications network. The desired information is associated with data identifying the user, the identifying data is conveyed to one or more recipient parties, and access is allowed to the recipients to the desired information in the repository based on the identifying data. The repository may be accessed through an information assistance service. The repository uses the identifying data to recognize the user when the user accesses the information at the repository. Recognition may be done, e.g., using automatic number identification (ANI) or a user voiceprint. The identifying data is also used to recognize the recipients.

Another aspect of the invention involves disseminating information using a repository. Data identifying a user are maintained at the repository. Information is received from the information source where it is associated with the identifying data. The information is then stored at the repository and released to selected recipients based on instructions from the user that include the identifying data. The identifying data are used to recognize the user and recipients when accessing the information at the repository.

Advantageously, the invention allows a user to search for information from a number of different sources, have the information transferred to a central repository, access the saved search information at the central repository, and grant others the ability to access the saved search information at the central repository.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 illustrates a communications system including information/call centers in accordance with an embodiment of the invention;

FIG. 2 illustrates an arrangement including a caller terminal and an information/call center in accordance with an embodiment of the invention;

FIG. 3 illustrates an information assistance service provider and a servicing platform for providing an information assistance service;

FIG. 4A illustrates an arrangement including an information source server and an information depot server in accordance with an embodiment of the invention;

FIG. 4B illustrates a routine for searching for information and transferring it to an information depot in accordance with an embodiment of the invention;

FIG. 4C is a schematic diagram of a data record stored at an information depot in accordance with an embodiment of the invention;

FIG. 5A illustrates a routine for notifying recipients of the availability of search results in an information depot in accordance with an embodiment of the invention; and

FIG. 5B illustrates a routine for retrieving search results from an information depot in accordance with an embodiment of the invention.

### DETAILED DESCRIPTION

The present invention is directed to searching for information at an information source, transferring received search results and information to a repository, herein referred to as an “information depot,” associating the received information with identifying data, and accessing the search results and information at the information depot based on the identifying data. The information depot is exemplified herein as being part of an information hub in an information/call center network of an information assistance service. The search results and information at the information depot are accessible by the user and by recipients selected by the user.

In a typical directory assistance call, a caller identifies to the operator the name and address (sometimes city or area code) of a party whose telephone number is desired. In response, the operator locates the desired destination telephone number using, e.g., a computer database. The destination number is then provided to the caller, e.g., by a voice server which provides automated voicing of the number, and the caller is afforded an option to be connected to the destination number without the need of first terminating the directory assistance call.

Information assistance is an extension of directory assistance. In addition to connecting a caller to a destination number, information assistance operators can provide concierge-type services such as a restaurant guide and reservation service, event ticketing and reservation service, hotel reservation and availability service, travel or flight reservation and ticketing services, ordering specific items such as flowers or food delivery, arranging transportation, and accessing entertainment guides. The use of information assistance to provide such concierge-type services is disclosed, e.g., in commonly-assigned, co-pending U.S. application Ser. No. 09/520,306, “Technique for Providing Information Assistance Including Concierge-Type Services,” filed Mar. 7, 2000, incorporated herein by reference.

In addition, if a caller subscribes to an information assistance service, the information assistance service may develop one or more user profiles that include information pertaining to and about the caller, including preferences for handling calls from the caller and methods of identifying the caller based on the caller's telephone number, voiceprint, PIN (personal identification number), etc. These profiles may also include the caller's personal preferences about restaurants, movies, sporting events, or hobbies. It should noted at this point that the methodology for identifying a caller using his/her voiceprint is fully described, e.g., in copending, commonly assigned U.S. application Ser. No. 10/403,207, filed on Mar. 31, 2003, incorporated herein by reference.

Moreover, information assistance service subscribers may use an information management service to retain information folders, such as contacts folders (also known as private directories), appointments folders (also known as calendars), to-do lists, and notes. A caller may access a contacts folder to connect to a desired contact, retrieve an appointment or to-do list item, or set up a new contact, appointment, or to-do list item. A contacts folder contains contact information, such as telephone number, postal address, and e-mail address, for people and/or organizations. Each of the user's contacts includes at least a telephone number, and likely includes an associated name, which may be a full or real name of the contact (e.g., Joseph Johnson) or may be a nickname or alias (e.g., Joe or “JJ”). The associated address may be a full address, including number, street, city, state, postal code, and country, or may be a partial address, e.g., only including a street name or a city. A user may have separate contacts folders for different purposes, such as a personal contacts folder, a business contacts folder, a sports team contacts folder, etc. These folders are stored in a database accessible to an information/call center and its operators. The user may have specific rights with respect to a folder, e.g., owner, administrator, read-only, etc. When the user accesses a folder through an operator, the operator becomes an alter ego of the user and is subject to the same rights as the user with respect to the folder. The user may create, maintain, or access a contacts folder via the Internet or other communications means, or through an operator who in turn may create, maintain, or access the folder on behalf of the user. The user may be identified by an ANI (automatic number identification) or, alternatively, by, or in combination with, a user identification (ID), password, PIN, mother's maiden name, user voice recognition, user voiceprint, etc. The use of information assistance to provide these types of information management services and to maintain the folders is disclosed, e.g., in U.S. Pub. No. 2002/0055351 A1, published May 9, 2002, incorporated herein by reference.

An expansive network of information/call centers may be used from which operators can effectively provide users with personalized information and communications services. Such services may include, e.g., providing directory information, movie listings, restaurant recommendations, driving directions to various places, etc.; making reservations; sending invitations; administering appointment calendars; ticketing; and conducting other transactions for the users. The term “operator” used herein broadly encompasses entities that are capable of providing information assistance in a telecommunications environment, including, without limitation, human operators, voice response/recognition capabilities, web-/WAP-enabled operator services, and other automated and electronic access.

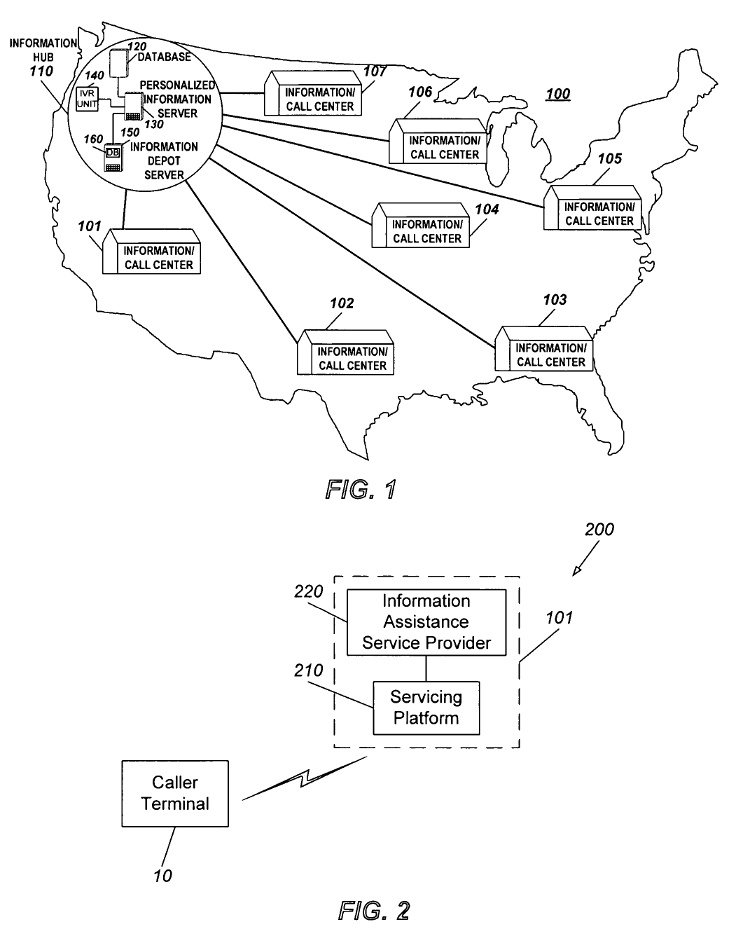

FIG. 1 illustrates a system embodying aspects of the invention, which includes wide area network (WAN) 100 covering an extensive area. WAN 100 can be an intranet-based network or an Internet-based network such as the World Wide Web. In this illustrative embodiment, WAN 100 connects operators dispersed throughout a wide coverage area in information/call centers 101-107. Each of information/call centers 101-107 covers one or more regional coverage areas. One or more information hubs 110 are also included in WAN 100. An information hub 110 includes one or more personalized information servers 130 which are accessible by the operators in the system and one or more databases 120 in which users' contacts, appointments, and other folders and information are stored and maintained. Information hub 110 also includes an information depot server 150 having a database 160 in which users' search results are stored and maintained. Information hub 110 may also include interactive voice response (IVR) unit 140 connected to server 130 for interacting with the user by voice, e.g., announcing to the user selected appointments. In addition to storing folders and information in information hub 110, they may also be stored locally at one or more of the information/call centers. The folders and information at different centers are synchronized. Synchronized databases provide necessary backup as well as support to roaming mobile device users.

In operation, a user dials a designated access number, e.g., “411,” “*555,” “555-1212,” “00,” etc., and the call is routed to, say, information/call center 101 where an operator attends to the call. The user may be identified by an ANI (automatic number identification) or, alternatively, by, or in combination with, a user identification (ID), password, PIN (personal identification number), mother's maiden name, user voice recognition, user voiceprint, etc. In the case in which the user desires an information assistance service, such as a directory assistance, information management, or concierge-type service, the user makes such a request to the operator and the operator accesses personalized information server 130 through WAN 100 (or alternatively via the Internet). In response, server 130 presents on the operator's terminal various graphical user interface (GUI) dialog boxes, e.g., “login” (for confirming the user's identity via User ID and password), “home” (listing the user's contacts, appointments, and other folders), “edit” (for editing specific folder contents), and “view” (for viewing folder contents), for interacting with the operator.

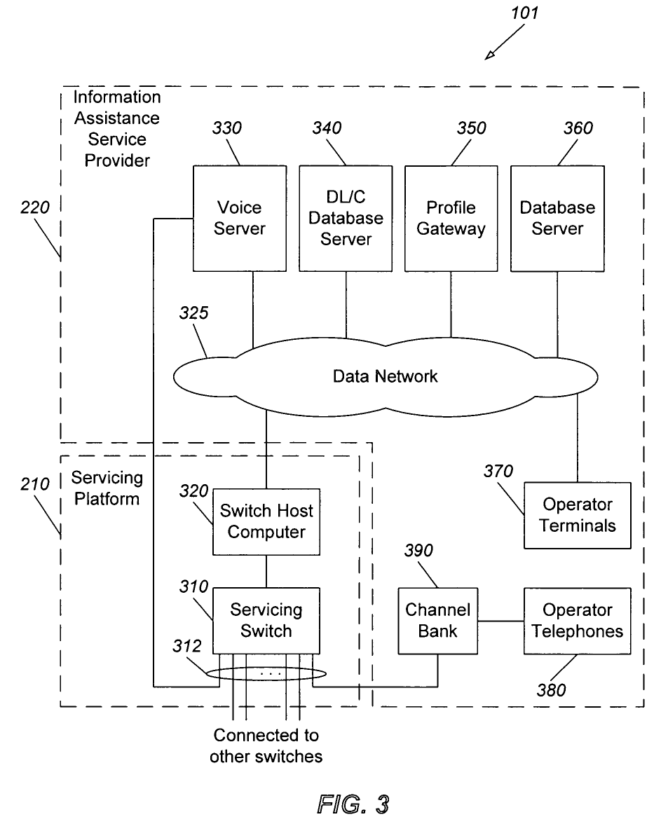

FIG. 2 illustrates system 200 in which a caller initiates an information assistance call from caller terminal 10, which is routed to, say, information/call center 101 via one or more carrier switches in a carrier network, e.g., a public switched telephone network (PSTN), a wireless telephone network, etc. Information/call center 101 generically represents any of the aforementioned information/call centers 101-107 shown in FIG. 1. Caller terminal 10 may comprise a wireless telephone, wireline telephone, personal digital assistant (PDA), computer, or other communication device. In this illustrative embodiment, users may dial, speak or otherwise communicate predetermined access digits, access codes or retail numbers, or input a predetermined address or URL (uniform resource locator) established by the carrier to access information/call center 101. In the example described above, the predetermined access digits may be “411,” “*555,” “555-1212,” “00,” etc. Once connected to information/call center 101, the user requests information assistance.

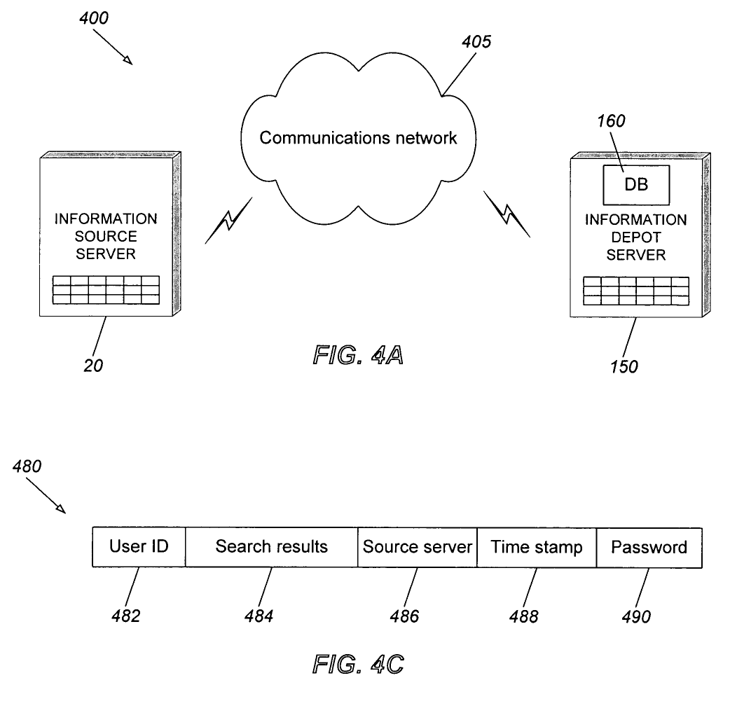

FIG. 3 illustrates information/call center 101, which may be configured to include information assistance service provider 220 together with servicing platform 210. It should be noted that even though both provider 220 and servicing platform 210 appear in the same figure, they may or may not be located in the same geographic area. Servicing platform 210 includes servicing switch 310 having T1 spans 312 or connections by other means for connection to one or more voice servers 330 (although only one is shown in the figure), channel bank 390, and one or more carrier networks. In an alternate embodiment, voice information may be packetized and transmitted pursuant to a VoIP (voice over IP (Internet Protocol)) protocol over a packet-switched network, e.g., the Internet, to information/call center 101. Servicing switch 310 may receive an incoming information assistance call from a carrier switch in a carrier network. Servicing switch 310 may also be used to place an outgoing call onto a carrier network, which may be different from the carrier network used for the incoming call.

Channel bank 390 in service provider 220 is used to couple multiple operator telephones 380 to servicing switch 310. The operators in information/call center 101 are further equipped with operator terminals 370, each of which includes a video display unit and a keyboard with an associated dialing pad. Operator terminals 370 are connected over data network 325 to one or more database servers 360 (although only one is shown in the figure). Operators may use database server 360 to provide information assistance including searching various databases in a manner described below to satisfy a caller's request. Other information assistance concerning restaurant recommendations, movie listings, events, etc. may also be provided by searching one or more internal and external databases, and the Internet. Switch host computer 320 and voice server 330 are also connected to data network 325. By way of example, data network 325 includes a local area network (LAN) supplemented by a number of point-to-point data links. Through data network 325 and routers (not shown), components of information/call center 101 may also be connected to the Internet or other wide area networks (WANs).

Servicing switch 310 is conventional and supports digital T1 or perhaps other connectivity. The operation of servicing switch 310 is governed by instructions stored in switch host computer 320. In this illustrative embodiment, servicing switch 310 includes, among other things, arrays of digital signal processors (DSPs). These DSPs can be programmed and reprogrammed to function as, among other things, call progress analyzers (CPAs), call progress generators (CPGs), multi-frequency (MF) tone generators/detectors, voice recognizers, dual-tone multi-frequency (DTMF) generators/detectors, or conference units, depending on the demand placed on information/call center 101 and servicing switch 310 for each corresponding function.

An incoming call requesting information assistance is received by servicing switch 310 in information/call center 101, which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 320 or elsewhere in information/call center 101. In other instances, other distribution logic schemes may be utilized, such as skills-based routing or a priority scheme for preferred users. In a preferred embodiment, when the information assistance call is received by servicing switch 310 in information/call center 101, switch 310 derives, in a well-known manner, from the signaling associated with the call the caller's phone number from which the call originates, known as ANI.

Voice server 330 (also known as a “voice response unit” or “VRU”) is used to play the constant repeated parts of an operator's speech, namely, the various greetings and signoffs (or closings) as well as other information portions of a call. Voice server 330 is connected via data network 325 to switch host computer 320 and via one or more T1 spans 312 to servicing switch 310. Voice server 330 may comprise a general-purpose computer and one or more voice cards for voice recognition, voice recording and playback, and call progress analysis. At appropriate stages in a call progression, switch host computer 320 initiates a voice path connection between voice server 330 and servicing switch 310 such that the user, or the user and the operator, are able to hear whatever pre-recorded speech is played on that connection by voice server 330. Computer 320 then instructs voice server 330, via data network 325, what type of message to play, and passes data parameters that enable voice server 330 to locate the message appropriate to the call state.

Data network 325 may further connect to directory listing/concierge (DL/C) database server 340. DL/C database server 340 may contain directory listing information on restaurants, events, accommodations, transportation, travel information and booking, stock prices, weather, and other services such as grocery or flower delivery, etc. Together, DL/C database server 340 and database server 360 provide operators with the means to search for a caller's desired party and determine the appropriate telephone number. Preferably, these databases can search not only by name and address, but also by type of goods/services and/or geographical region, or by any other attribute in the caller record, including phone number. For example, DL/C database server 340 can answer queries soliciting the names/numbers of restaurants serving a desired cuisine on a given street.

Data network 325 may also connect to a profile gateway 350. Profile gateway 350 provides access to a user profile, which may include personal information and the subscriber's preferences. Such personal information and preferences may include the subscriber phone number, fax number, e-mail address, preferred restaurant and dining time, preferred mode of delivery of information to him/her, dietary requirements, likes and dislikes, past logged activities, specific service subscriptions, etc. When the information assistance call is received by servicing switch 310 in information/call center 101, switch 310 derives the aforementioned ANI from the call setup signaling associated with the call. Switch host computer 320 then requests via profile gateway 350 any profile identified by such an ANI. An embodiment of profile gateway 350 may include a data network interface, a communications interface, a processor, and memory. Profile data may be input and updated (e.g., via Internet web pages or operator) through a remote profile manager (not shown). Copies of the profile data are distributed to the profile gateways in various information/call centers (e.g., center 101) connected via WAN 100. In response to a request for a profile, the processor in the profile gateway searches the memory (which may include disks, caches, and volatile and nonvolatile memories) for the profile identified by the ANI. When the operator answers the call, computer 320 communicates to components in information assistance service provider 220 and, in particular, the operator through terminal 370 any profile data pertinent to the handling of the call. In this instance, the personal profile may indicate that the user is a subscriber to the information management service described before. In accordance with an aspect of the invention, the user may be afforded the option to send to one or more contacts in a selected contacts folder managed by the information management service the search results or other information forwarded by an information source.

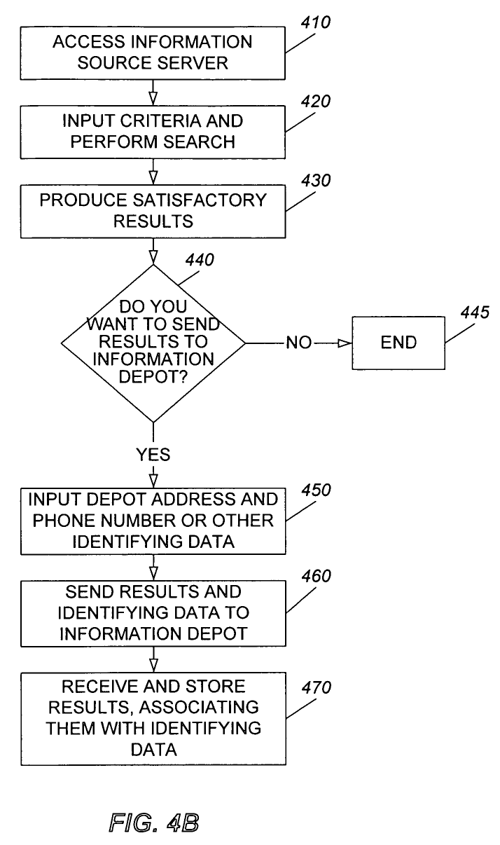

FIG. 4A is a block diagram of arrangement 400 illustrating the interaction between an information source and the information depot server. An information source server 20 is in communication with information depot server 150 (located in information hub 110, as shown in FIG. 1) via communications network 405. A user may perform a search using information source server 20, and then direct information source server 20 to send the search results or other information to information depot server 150, through which the information will be kept in database 160 and be made available through the information assistance service. Communications network 405 can be a computer network such as the Internet or an intranet, or a telephone network such as the PSTN or a private telephone network.

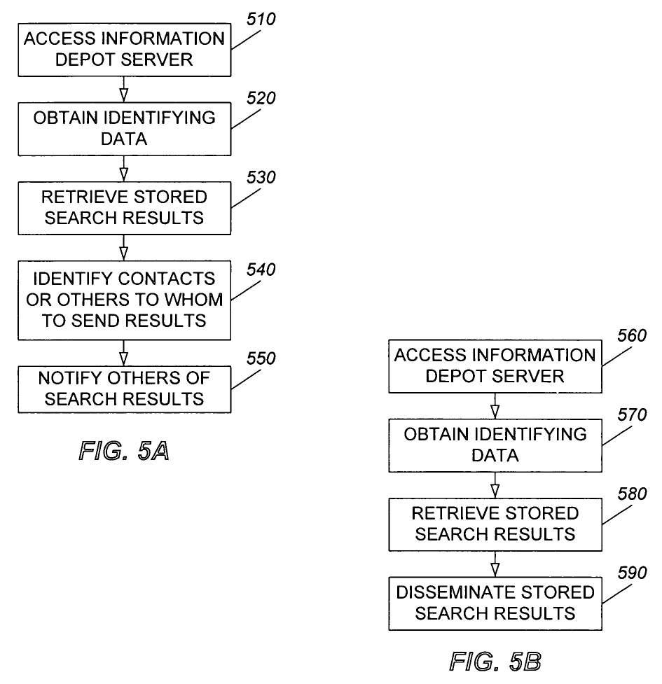

The invention involves searching for information from an information source, transferring the information to the information depot, authorizing selected recipients to access the information, and accessing the information at the information depot. Flowcharts illustrating these aspects are provided in FIGS. 4B, 5A, and 5B.

FIG. 4B is a flowchart illustrating searching for information from information source server 20 and transferring the search results and information to information depot server 150. Information source server 20 may be a server of a website containing a telephone directory such as white pages or yellow pages, a map database, an event database (possibly including the ability to purchase tickets), a transportation website (e.g., airline, train, or bus), a library catalog, a real estate listing service, a retailer's or manufacturer's product catalog, a business-to-business swap site, a shopping comparison site, etc. In step 410, a user accesses information source server 20, e.g., through the Internet at a predetermined URL (uniform resource locator). As is well known, the user may be allowed to input criteria, as in step 420. The specific criteria allowed vary depending on the website. For example, for a white pages telephone directory, the user may input one or more of last name, first name, street name, city, state, or ZIP code. For a yellow pages telephone directory, the user may input part of the business name, the business category, a street name, city, state, or ZIP code, or distance from a specific location. For an event database, the user may input the performer name, performing venue, performance date, or type of entertainment. In some cases, the user may just input one or more keywords, rather than specifying certain criteria. When the criteria and/or keywords have been input, information source server 20 performs the search.

The results of the search are then returned to the user. After reviewing the results, the user may broaden or narrow the search criteria and/or keywords to produce more or fewer results. Step 430 indicates that, at some point, the user receives satisfactory results.

Once satisfactory results are received in step 430, step 440 asks the user about sending the results and information to information depot server 150. If the user does not want to send the results, the routine ends in step 445. However, if the user wants to save the results for later or send the results to one or more people, the user responds affirmatively. In that case, in step 450, information source server 20 prompts the user to input (1) the address of information depot server 150 and (2) data or other information identifying the user (“identifying data”) to information depot server 150. There may also be a provision for inputting a password if the search results or information are confidential. In this illustrative embodiment, the address of information depot server 150 is most likely a URL identifying an Internet address. If information depot server 150 is accessed via an information assistance service, the identifying data may be the user's account number or username with the information assistance service, the user's phone number, or the phone number from which the user or other person may access the information assistance service. If information depot server 150 is accessible via another type of service, the identifying data may be a username or user ID. In step 460, information source server 20 transfers via communications network 405 to information depot server 150 the identifying data and the search results and information found using information source server 20 (and the password if provided).

In step 470, information depot server 150 receives the results and stores them, associating the results with the identifying data in a record 480, illustrated in FIG. 4C. In addition to the identifying data 482 and the search results 484, record 480 may also include the source server address or name 486 and a time stamp 488 to identify the date and time the search results were stored. Record 480 may also include a password 490, as discussed above. Record 480 may be stored in memory in database 160. Once the results are stored in database 160 and associated with the user, information depot server 150 awaits further instructions from the user as to how to use the search results or further distribute them, as discussed below.

As a variation, instead of accessing the website provided by information source server 20 to perform a search, information source server 20 may be accessed via the telephone (step 410). The user may access an operator or customer agent to perform a search or may be able to follow voice prompts to find the desired information (e.g., retrieving airplane or train schedules). After receiving satisfactory results (step 430), the user is then prompted to have the results sent to the information depot, and, as identifying data, the user may use the phone number from which the call is made, or the phone number registered to the account at the information depot.

FIG. 5A is a flowchart illustrating authorizing selected recipients to access the information stored at information depot server 150. The user first accesses information depot server 150, as shown in step 510. This may be done via telephone, by calling the information assistance service, or by accessing the information assistance service's website. Next, in step 520, information depot server 150 obtains the user's identifying data. If the user is calling via telephone, the operator (or voice response system) at information/call center 101 may identify the user using the ANI or voiceprint or the user may tell the operator or punch in using the touch-tone keys a usemame or number. There may also be a PIN in order to further identify the user. If the user is accessing the depot via a website, the user may input the usemame or number, and PIN, or there may be a cookie on the user's computer that contains such information and transmits it to information depot server 150 upon login. Once the identifying data are obtained, in step 530, the server retrieves from database 160 all stored search result records associated with the identifying data, and identifies to the user the results by time stored and source.

In step 540, the user identifies to the operator the recipients of the search results. These recipients may be individual contacts, contacts in a contacts folder, e.g., soccer team folder, or names that the user inputs. The user also informs the operator by what method (e.g., e-mail, fax, short messaging service (SMS), voice, PDA, etc.) each recipient should be notified. In step 550, the information assistance service notifies the recipients that the search results are available. This notification may be made by sending each recipient an e-mail with a note from the user that the search results are available and including a hyperlink to the information assistance service website to access the results. Notification may be made via fax, including a note from the user that the search results are available and including identifying data, such as the user's usemame or phone number, and a toll free (e.g., 1-800) number or TURL to use to access the results. Notification may also be made to a recipient's PDA, wireless phone, or voicemail, again including a note from the user, a telephone number or URL to access an information assistance service, and identifying data to access the results.

Next is for the user and/or recipients to access the results stored at information depot server 150, illustrated by the flowchart in FIG. 5B. The first three steps are similar to those in the flowchart in FIG. 5A. In step 560, the user or recipient accesses information depot server 150 by telephone or by accessing the information assistance service's website. In step 570, information depot server 150 obtains the user's identifying data. If calling via telephone, the operator (or voice response system) at information/call center 101 may identify the user using the ANI or voiceprint or the user or recipient may tell the operator or punch in using the touch-tone keys a usemame or number. This usemame or number was included in the notification e-mail, fax, voicemail, PDA, or wireless phone as described above in step 550. A PIN may be used to further identify the user or recipient. If the user or recipient is accessing the information depot via a website, the user or recipient may input the usemame or number, and PIN. A recipient who received a notification e-mail may click on the hyperlink in the e-mail, and this may bring the recipient to the website and, if the link includes the identifying data, may identify the recipient as accessing the saved search results. Once the identifying data are obtained, in step 580, the server retrieves from database 160 all stored search result records associated with the identifying data, and identifies to the user or recipient the results by time stored and information source. If a password is required to access the results, the operator requests the password.

In step 590, information depot server 150 disseminates the stored search results. If on a website, the user or recipient can view them on the computer screen. If via telephone, the user or recipient may have the results read to him or her by the operator. The user or recipient may request the search results to be transmitted via facsimile or SMS. In addition, the user or recipient may download the search results to a PDA or other electronic device or have the results sent to an e-mail address.

An alternative way for the recipient to access the search results is for information depot server 150 to send the search results directly to the recipient, e.g., via e-mail, fax, or by calling the recipient's telephone number and speaking with the person, without the recipient having to separately access the information depot server. Thus, instead of notifying the recipient that search results are available, as in step 550, the search results are delivered directly to the recipient.

These aspects of the invention are illustrated in some more detail here. If the search results are, for example, driving directions, after accessing the information depot server and providing the user's identifying data, per step 540 the user informs the information depot server whom to notify that the directions are available. The information depot server sends out a notification to each recipient including a note from the user describing the search results (e.g., “I have found directions to Grandma's house. You can access them by clicking on the following link.”), and a link (or identifying data and a phone number or URL) to access the directions. The recipient follows these instructions, accesses the information depot server (step 560), provides the identifying data (step 570), and is provided with the search results (step 590). The user is also able to access the driving directions, and may download them to a PDA, e-mail, fax, or wireless phone to be used later while driving. Alternatively, the user or recipient may access the information depot server while in a car driving to the destination, and the operator can read the directions to the user or recipient at that time. As noted above, instead of sending a notice to the recipients that the search results are available, the information depot server may deliver them directly to the recipients.

There are several variations of the illustrative flowcharts in FIGS. 4B, 5A, and 5B. In FIG. 4B, in step 450, when deciding where to transfer the search results, in addition to inputting the depot address and the user's username or other identifying data, there may be a multi-purpose field, e.g., a “comments” field, to fill in on the information source server's website in which the user may specify information about the search results that information depot server 150 may decipher. For example, the comments field may include recipients of the search results, and the user may include in that field the names of various contacts, by, e.g., name or alias or e-mail address. When the search results are transferred to information depot server 150, that server retrieves the profile associated with the usemame given, recognizes the contacts folders associated with that user, and decodes the information in the comments field to identify contacts to whom to send the search results. Then, without the user having to access information depot server 150 as in FIG. 5A, information depot server 150 performs step 550 and notifies the recipients identified in the comments field or skips steps 550-580 (in FIGS. 5A and 5B) and sends the search results directly to the recipients.

In another variation, there is some affinity or affiliation between information source server 20 and information depot server 150 so that there exists on the source server's website a hyperlink to information depot server 150. This link obviates the need to specify the depot address in step 450.

In another variation, the user is not a subscriber to the information assistance service, so no contacts or contacts folders or profile exist for the user. Nevertheless, the user may specify information depot server 150 as the depot for search results from information source server 20. The user inputs in step 450 the depot address and user ID, which, in this case, may be the user's home phone number. When the user accesses information depot server 150 (step 510) to provide a list of recipients, the operator derives the user ID from the ANI or by asking the user (step 520). Then, in step 540, the user specifies to the operator the recipients' e-mail addresses or phone numbers, and information depot server 150 notifies the recipients of the results. Similarly, when the user or recipient accesses information depot server 150 (step 560) to retrieve the results, the operator may derive the user ID from the ANI or by asking the user or recipient (step 570). Then, in step 590, information depot server 150 disseminates the search results as discussed above.

Additional advantages and modifications of the invention will readily occur to those skilled in the art. For example, an added advantage of the invention is the ability to accumulate search results from multiple information sources in one place, the information depot, and then review them later. To that end, a user can specify as part of the user's profile with an information source server website to transfer all search results to the information depot automatically or to ask to confirm the transfer after each search.

Information/call center 101 is disclosed herein in a form in which various functions are performed by discrete functional blocks. However, any one or more of these functions could equally well be embodied in an arrangement in which the functions of any one or more of those blocks or, indeed, all of the functions thereof are realized, for example, by one or more appropriately programmed processors.

Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

1. A method for use in a system enabling a user to share desired information with one or more parties, the user searching an information source remote from the system for the desired information, the system including a repository, the method comprising:
storing in the repository the desired information from the information source; the information source being directed to send the desired information to the system via a communications network, the desired information being associated with data identifying the user;
conveying the identifying data to the one or more parties; and
allowing access by the one or more parties to the desired information in the repository based on the identifying data.

2. The method according to claim 1, wherein the repository is accessed through an information assistance service.

3. The method according to claim 1, wherein the repository is accessible via a telephone.

4. The method according to claim 1, wherein the repository is accessible via the Internet.

5. The method according to claim 1, wherein the information source is accessible via the Internet.

6. The method according to claim 1, wherein the information source is accessible via a telephone.

7. The method according to claim 1, further comprising allowing the user to access the desired information in the repository.

8. The method according to claim 7, wherein the user is recognized by the system using an automatic number identification (ANI).

9. The method according to claim 7, wherein the user is recognized by the system using the user's voiceprint.

10. The method according to claim 1, wherein the system uses the identifying data to recognize the one or more parties when accessing the information in the repository.

11. A method for disseminating information using a repository, comprising:
maintaining at the information depot data identifying a user;
receiving information from an information source, the information being associated with the identifying data;
storing the information in the repository; and
releasing the information to selected recipients based on instructions from the user that include the identifying data.

12. The method according to claim 11, wherein the repository is accessed through an information assistance service.

13. The method according to claim 11, wherein the repository is accessible via a telephone.

14. The method according to claim 11, wherein the repository is accessible via the Internet.

15. The method according to claim 11, wherein the information source is accessible via the Internet.

16. The method according to claim 11, wherein the information source is accessible via a telephone.

17. The method according to claim 11, further comprising using the identifying data to recognize the user when the user accesses the information at the repository.

18. The method according to claim 17, wherein the user is recognized using automatic number identification (ANI).

19. The method according to claim 17, wherein the user is recognized using the user's voiceprint.

20. The method according to claim 11, further comprising using the identifying data to recognize the recipients when accessing the information at the repository.

21. A system for disseminating information using an repository, comprising:
a gateway for maintaining data identifying a user;
an interface for receiving information from an information source, the information being associated with the identifying data; and
a database for storing the information in the repository,
wherein the information is released to selected recipients based on instructions from the user that include the identifying data.

22. The system according to claim 21, wherein the repository is accessed through an information assistance service.

23. The system according to claim 21, wherein the repository is accessible via a telephone.

24. The system according to claim 21, wherein the repository is accessible via the Internet.

25. The system according to claim 21, wherein the information source is accessible via the Internet.

26. The system according to claim 21, wherein the information source is accessible via a telephone.

27. The system according to claim 21, wherein the identifying data is used to recognize the user when accessing the information at the repository.

28. The system according to claim 27, wherein the user is recognized using automatic number identification (ANI).

29. The system according to claim 27, wherein the user is recognized using the user's voiceprint.

30. The system according to claim 21, wherein the identifying data is used to recognize the recipients when accessing the information at the repository.
